(19) United States
(12) Patent Application Publication
(10) Pub. No.: US 2026/0067817 A1
(43) Pub. Date: Mar. 5, 2026

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Qiujin GUO, Shenzhen (CN); Mengzhu CHEN, Shenzhen (CN); Bo DAI, Shenzhen (CN); Kun LIU, Shenzhen (CN); Jun XU, Shenzhen (CN); Youjun HU, Shenzhen (CN); Weiwei YANG, Shenzhen (CN)

(73) Assignee: ZTE CORPORATION, Shenzhen (CN)

(21) Appl. No.: 19/385,127

(22) Filed: Nov. 10, 2025

Related U.S. Application Data
(63) Continuation of application No. PCT/CN2023/094303, filed on May 15, 2023.

(51) Int. Cl. H04W 52/02; H04L 27/26

(52) U.S. Cl. CPC H04W 52/0235; H04L 27/2636

(57) ABSTRACT

A wireless communication method is disclosed. The method comprises determining, by a first wireless communication node, one or more types of a low power, LP, signal according to information; and receiving, by the first wireless communication node from a second wireless communication node, the one or more types of the LP signal; and wherein the LP signal comprises at least one of a low power wake-up signal (LP-WUS), a low power synchronization signal (LP-SS), or a physical downlink control channel (PDCCH); or wherein the information comprises at least one of information configured by the second wireless communication node or information indicated by the LP signal.

### CROSS-REFERENCE TO RELATED PATENT APPLICATIONS

This application is a continuation of International Patent Application No. PCT/CN2023/094303, filed May 15, 2023, which is herein incorporated by reference in its entirety.

### TECHNICAL FIELD

This document is directed generally to wireless communications, and in particular to 5th generation (5G) communications or 6th generation (6G) communications.

### BACKGROUND

The LP-WUS (Low Power Wake-Up Signal) is a signal in 5G communication that enables energy-efficient device activation and communication. It allows devices to enter a low-power state while still being responsive to incoming data. The LP-WUS utilizes a dedicated wake-up signal, which is a short and low-energy transmission, to efficiently wake up devices only when necessary. The LP-WUS helps to conserve battery life and enhances the overall power efficiency of 5G networks, making it ideal for applications that require intermittent or infrequent data transmission. However, detail configurations of low power signals are still a topic to be discussed.

### SUMMARY

This document relates to methods, systems, and computer program products for a wireless communication.

One aspect of the present disclosure relates to a wireless communication method. In an embodiment, the wireless communication method includes: determining, by a first wireless communication node, one or more types of a low power, LP, signal according to information; and receiving, by the first wireless communication node from a second wireless communication node, the one or more types of the LP signal; and wherein the LP signal comprises at least one of a low power wake-up signal, LP-WUS, a low power synchronization signal, LP-SS, or a physical downlink control channel, PDCCH; and/or wherein the information comprises at least one of information configured by the second wireless communication node or information indicated by the LP signal.

Another aspect of the present disclosure relates to a wireless communication method. In an embodiment, the wireless communication method includes: transmitting, by a second wireless communication node to a first wireless communication node, one or more types of a low power, LP, signal, wherein the first wireless communication node determines the one or more types of the LP signal according to information; and wherein the LP signal comprises at least one of a low power wake-up signal, LP-WUS, a low power synchronization signal, LP-SS, or a physical downlink control channel, PDCCH; and/or wherein the information comprises at least one of information configured by the second wireless communication node or information indicated by the LP signal.

Another aspect of the present disclosure relates to a wireless communication node. In an embodiment, the wireless communication node includes a communication unit and a processor. The processor is configured to: determine one or more types of a low power, LP, signal according to information; and receive, via the communication unit from a second wireless communication node, the one or more types of the LP signal; wherein the LP signal comprises at least one of a low power wake-up signal, LP-WUS, a low power synchronization signal, LP-SS, or a physical downlink control channel, PDCCH; and/or wherein the information comprises at least one of information configured by the second wireless communication node or information indicated by the LP signal.

Another aspect of the present disclosure relates to a wireless communication node. In an embodiment, the wireless communication node includes a communication unit and a processor. The processor is configured to: transmitting, by via the communication unit, to a first wireless communication node, one or more types of a low power, LP, signal, wherein the first wireless communication node determines the one or more types of the LP signal according to information; wherein the LP signal comprises at least one of a low power wake-up signal, LP-WUS, a low power synchronization signal, LP-SS, or a physical downlink control channel, PDCCH; and/or wherein the information comprises at least one of information configured by the second wireless communication node or information indicated by the LP signal.

Various embodiments may preferably implement the following features:

Preferably or in some embodiments, the LP signal indicates indication information comprising at least one of:
a wake-up indication;
index information;
format information;
system information, SI, change information;
Subcarrier Spacing, SCS, information;
a transmission pattern;
an availability of the LP signal;
a capability of an LP signal receiver?
a type of the LP signal;
a capability of the LP signal;
Earthquake and Tsunami Warning System, ETWS, information; or
Commercial Mobile Alert System, CMAS, information.

Preferably or in some embodiments, the one or more types of an LP signal comprise at least one of:
a first type of the LP signal comprising at least one of a first signal format, a first set of indication information, a first generation procedure, a first modulation method, a first function, a first monitoring method, a first waveform or a first size of information; wherein the first signal format comprises a raw sequence;
a second type of the LP signal comprising at least one of a second signal format, a second set of indication information, a second generation procedure, a second modulation method, a second coding operation, a second function, a second monitoring method, a second waveform or a second size of information; wherein the second signal format comprises a modulated or coded sequence;
a third type of the LP signal comprising at least one of a third signal format, a third set of indication information, a third generation procedure, a third modulation method, a third coding operation, a third function, a third monitoring method, a third waveform or a third size of information; wherein the third signal format comprises a first data packet;
a fourth type of the LP signal comprising at least one of a fourth signal format, a fourth set of indication information, a fourth generation procedure, a fourth modulation method, a fourth coding operation, a fourth function, a fourth monitoring method, a fourth waveform or a fourth size of information; wherein the fourth signal format comprises a second data packet;
a fifth type of the LP signal comprising any two or more of the first type of the LP signal, the second type of the LP signal, the third type of the LP signal, the fourth type of the LP signal and the fifth type of the LP signal; wherein the fifth signal format comprises at least one of: the first type of the LP signal, the second type of the LP signal, or one of the third and fourth type of the LP signal; or
a sixth type of the LP signal comprising at least one of a sixth signal format, a sixth set of indication information, a sixth generation procedure, a sixth modulation method, a sixth coding operation, a sixth function, a sixth monitoring method, a sixth waveform or a sixth size of information; and wherein the sixth signal format comprises a PDCCH.

Preferably or in some embodiments, the first type of the LP signal satisfies at least one of:
the first signal format carrying the first set of indication information including at least one of cell ID information, a wake-up indication, SI change information, format information or a transmission pattern;
the first signal format being generated based on the first generation procedure including a raw sequence generation related to at least one of: an m-sequence, a pseudo noise, PN, sequence, a Zadoff Chu, ZC, sequence, a Secondary Synchronization Signal, SSS, sequence, a Primary Synchronization Signal, PSS, sequence, a low peak to average power ratio, PAPR, sequence, a preamble, a time/frequency domain resource, a group index, a cell ID, a paging occasion, PO, index, or index information;
an initial value of at least one of an m-sequence, a PN sequence, a scrambling sequence, or a phase factor is determined by at least one of a time/frequency domain resource, a group index, a cell ID, a PO index or index information; or
the first modulation method comprises at least one of: modulating an information bit by a raw sequence, or a multiplexing mode among multiple candidate raw sequences comprises at least one of a time division multiplexing, TDM, a frequency division multiplexing, FDM, or a code division multiplexing, CDM;
the first function comprising at least one of a Radio Resources Management, RRM, measurement, a time/frequency domain offset estimation, a cell identify, carrying a part of indication information of the LP signal or a synchronization;
the first waveform comprising at least one of a Cyclic Prefix Orthogonal Frequency Division Multiplexing, CP-OFDM, or a discrete Fourier transform-spread orthogonal frequency-division multiplexing, DFT-s-OFDM;
the first size of information is not less than 1 bit and not larger than 8 bits; or
the first monitoring method comprising at least monitoring the third signal format according to a configuration of one or more higher layer parameters.

Preferably or in some embodiments, the second type of the LP signal satisfies at least one of:
the second signal format carrying a second set of indication information including at least one of a wake-up indication, index information, a format information, SI change information or an availability of LP signal;
the second signal format being generated based on the second generation procedure including a second modulation method or a second coding operation; wherein the second modulation method includes at least one of: a sequence, an on-off keying, OOK, modulation, a frequency shift keying, FSK, modulation, a Zadoff Chu, ZC, sequence, a long low PAPR sequence, or a low PAPR sequence; and wherein the second coding operation includes at least one of: a Reed-Muller, RM, code, a convolutional code or a Manchester code.
the second modulation method comprises modulating an information bit by the second modulation method and/or a multiplexing mode among multiple modulated or coded sequences comprising at least one of a time division multiplexing, TDM, a frequency division multiplexing, FDM, or a code division multiplexing, CDM;
the second function comprising at least one of synchronization and/or indicating indication information of LP signal;
the second waveform comprising at least one of CP-OFDM or DFT-s-OFDM or OOK waveform or FSK waveform;
the second size of information that is not less than 1 bit and is not larger than 64 bits; or
the second monitoring method comprising at least monitoring the third signal format according to the configuration of higher layer parameter.

Preferably or in some embodiments, the third type of the LP signal satisfies at least one of:
the third signal format carrying a third set of indication information including at least one of a wake-up indication, index information, a format information, SI change information, a transmission pattern, an availability of LP signal, ETWS information or CMAS information;
the third signal format being generated based on the third generation procedure including a third modulation method and a third coding operation; wherein the third modulation method includes at least one of: an OOK modulation, a FSK modulation, a binary phase shift keying, BPSK, modulation, a quadrature phase shift keying, QPSK, modulation, a scrambling sequence, or a sequence-based modulation; and wherein the third coding operation includes a Manchester code, a Reed-Muller, RM, code, a convolutional code, a polar code, or a pulse interval encoding, PIE;
a first DMRS corresponding to the third type of the LP signal and the first data packet are multiplexed using a TDM; or
the third function comprising at least one of synchronization and/or indicating indication information of LP signal;
the third waveform comprising at least one of CP-OFDM or DFT-s-OFDM or OOK waveform or FSK waveform;
the third size of information that is not less than 2 bits and not larger than 256 bits; or
the third monitoring method comprising at least monitoring the third signal format according to the configuration of higher layer parameter.

Preferably or in some embodiments, the fourth type of the LP signal satisfies at least one of:
the fourth signal format carrying a fourth set of indication information including at least one of a wake-up indication, index information, a format information, SCS information, SI change information, a transmission pattern, an availability of LP signal, ETWS information or CMAS information;
the fourth signal format being generated based on the fourth generation procedure including a fourth modulation method and a fourth coding operation; wherein the fourth modulation method includes at least one of: an OOK modulation, a FSK modulation, a binary phase shift keying, BPSK, modulation, a quadrature phase shift keying, QPSK, modulation, a scrambling by a sequence, or a sequence-based modulation; and wherein the fourth coding method includes at least one of: a convolutional code, a polar code or a Manchester code;
a second DMRS corresponding to the fourth type of the LP signal and the second data packet are multiplexed using FDM or TDM or CDM;
the fourth function comprising indicating indication information of LP signal;
the fourth waveform comprising at least one of CP-OFDM or DFT-s-OFDM or OOK waveform or FSK waveform;
the fourth size of information that is not less than 2 bits and not larger than 256 bits; or
the fourth monitoring method comprising at least monitoring the fourth signal format according to the configuration of higher layer parameter.

Preferably or in some embodiments, the fifth type of the LP signal satisfies at least one of:
the fifth signal format comprising the first type of the LP signal indicating a first set of indication information and a second type of the LP signal indicating a fifth set of indication information including at least one of a wake-up indication, index information, a format information, SCS information, SI change information, a transmission pattern, an availability of LP signal, ETWS information, CMAS information or a time/frequency domain resource of the LP signal; or
the first type of the LP signal and the second type of the LP signal are multiplexed by a TDM, an FDM or a CDM.
the fifth signal format being generated based on the fifth generation procedure including a fifth modulation method or a fifth coding operation; wherein the fifth modulation method includes a first modulation method to generate the first signal format and a second modulation method to generate the second signal format; or wherein the fifth coding operation includes a second coding operation to generate the second signal format;
the fifth function comprising at least one of the first function or a second function;
the fifth waveform comprising at least one of CP-OFDM or DFT-s-OFDM or OOK waveform or FSK waveform;
the fifth size of information that is not less than 1 bit and is not larger than 64 bits; or
the fifth monitoring method comprising at least monitoring the second signal format after a reception of one of the first signal format.

Preferably or in some embodiments, the fifth type of the LP signal satisfies at least one of:
the fifth signal format comprising the one of the first and second type of the LP signal and the one of the third and fourth type of the LP signal; wherein the fifth signal format indicates the fifth set of indication information comprising one of a first and second set of indication information and one of a third and fourth set of indication information; or
the one of the first and second type of the LP signal and the one of the third and fourth type of the LP signal are multiplexed by using a TDM;
the fifth signal format being generated based on the fifth generation procedure including a fifth modulation method or a fifth coding operation; wherein the fifth modulation method includes one of a first modulation method and a second modulation method to generate one of the first signal format and the second signal format and one of a third modulation method and a fourth modulation method to generate one of the third signal format and the fourth signal format; and wherein a fifth coding operation includes one of a third coding operation and a fourth coding operation to generate one of the third signal format and the fourth signal format;
the fifth function comprising at least one of the first function and a second function, or one of the third function and a fourth function;
the fifth waveform comprising at least one of CP-OFDM or DFT-s-OFDM or OOK waveform;
the fifth size of information that is not less than 1 bit and is not larger than 256 bits; or
the fifth monitoring method comprising at least monitoring one of the third signal format and the fourth signal format after a reception of one of the first signal format and the second signal format.

Preferably or in some embodiments, the fifth type of the LP signal satisfies at least one of:
the fifth signal format comprising the first type of the LP signal, the second type of the LP signal, and one of the third type of the LP signal and the fourth type of the LP signal; wherein the fifth signal format indicates the fifth set of indication comprising at least one of the first set of indication information, the second set of indication information and one of a third and fourth set of indication information; or
the first type of the LP signal and the second type of the LP signal are multiplexed by using a TDM, an FDM, or a CDM; or wherein the first or second type of the LP signal comprised in the fifth type of the LP signal and the one of the third and fourth type of the LP signal comprised in the fifth type of the LP signal are multiplexed by using a TDM;
the fifth signal format being generated based on the fifth generation procedure including a fifth modulation method or a fifth coding operation; wherein the fifth modulation method includes a first modulation method and a second modulation method to generate the first signal format and the second signal format; and wherein a fifth coding operation includes one of a third coding operation and a fourth coding operation to generate one of the third signal format and the fourth signal format;
the fifth function comprising at least one of the first function, the second function, or one of the third function and a fourth function;
the fifth waveform comprising at least one of CP-OFDM or DFT-s-OFDM or OOK waveform;
the fifth size of information that is not less than 1 bit and is not larger than 256 bits; or
the fifth monitoring method comprising at least monitoring one of the third signal format and the fourth signal format after a reception of the second signal format.

Preferably or in some embodiments, the sixth type of the LP signal satisfies at least one of:
the sixth signal format carried by a PDCCH indicating a subset of indication information of the LP signal, wherein the subset of indication information comprises at least one of: a wake-up indication, index information, a format information, SCS information, SI change information, a transmission pattern, an availability of LP signal, ETWS information or CMAS information;
the sixth signal format being generated based on the sixth generation procedure including a sixth modulation method and a sixth coding operation to generate a downlink control information, DCI;
the sixth function comprising indicating indication information of LP signal;
the sixth waveform comprising at least one of CP-OFDM or DFT-s-OFDM;
the sixth size of information that is not less than 2 bits and not larger than the number of bits configured by higher layer parameter; or
the sixth monitoring method comprising at least monitoring the sixth signal format after a reception of a wake-up indication.

Preferably or in some embodiments, parameters in a resource of the LP signal comprise at least one of:
a number of user equipment, UE, subgroups;
a number of UE groups;
a group index;
a cell ID;
a PO index;
a number of UEs;
a payload size for a first, second, third, fourth, fifth or sixth type of the LP signal;
format information indicating that a type of LP signal comprises at least one of the first, second, third, fourth, fifth or sixth type of the LP signal;
cycle shift corresponding to a UE, a UE group, or a UE subgroup;
a search pace used to determine one or more monitoring occasions for the LP signal;
a frame offset used to determine a start of one or more monitoring occasions for the LP signal;
a first monitoring occasion for the LP signal;
a start physical resource block, PRB, index;
a number PRBs;
a PRB offset;
time domain resource information for a LP signal transmission;
an orthogonal cover code, OCC, index used for a DMRS or a sequence in a time/frequency domain or a frequency domain for a UE, a UE group, or a UE subgroup; or
a sequence index corresponding to an entry in a sequence pool or being used to determine an initial value of a sequence generation formula.

Preferably or in some embodiments, index information indicating at least one of a UE ID, a UE group ID, cell group ID, or a UE subgroup ID satisfies at least one of:
the index information being configured by a Radio Resource Control, RRC, release configuration;
the index information being assigned by a core network, CN, for a UE supporting an LP signal receiver, LP-WUR;
the UE ID indicating an order index of a corresponding UE among all UEs supporting LP-WURs; or
at least one of the UE group ID or the UE subgroup ID being determined by a UE ID for a UE supporting an LP-WUR.

Preferably or in some embodiments, the one or more types of the LP signal is determined according to the information including at least one of:
an indication of a type of the LP signal;
a length of information bits carried by the LP signal;
a number of a PRB for an LP signal transmission;
a number of slots for an LP signal transmission;
a length of a time duration for an LP signal detection;
an Energy Per Resource Element, EPRE, value;
a waveform;
a band;
a sequence generation formula;
a DMRS position;
a UE capability or UE type;
a wake-up indication method;
an information type;
an operation mode of the LP signal;
a Time Division Duplex, TDD, or Frequency Division Duplex, FDD;
a licensed or unlicensed band;
a coverage level;
an application scenario;
a link direction;
a length of a sequence used to generate the LP signal or to indicate indication information of the LP signal;
a value of a code rate or a transmission rate;
an encoding type;
an aggregation level, AL, of a Control Channel Element, CCE;
a search space type;
a number of transmissions for the LP signal;
a channel state information, CSI, process;
a frame number indicating a frame carries the LP signal;
a location index of cyclic redundancy check bits or truncation bits in a sequence processed by a modulation, a code, or a Discrete Fourier Transform, DFT; or
a carrier frequency carrying the LP signal.

Preferably or in some embodiments, for a detection of the LP signal, the first wireless communication node starts detecting a first type or a fifth type or a sixth type of the LP signal if the first wireless communication node does not detect a second type or a third type or a fourth type or a fifth type of LP signal; or
for a detection of the LP signal, the first wireless communication node starts detecting the LP signal with a first modulation method if the first wireless communication node does not detect the LP signal with a second or a third or a fourth modulation method.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a modulated sequence generation procedure according to an embodiment of the present disclosure.

FIG. 2 shows a flowchart of a sequence generation according to an embodiment of the present disclosure.

FIG. 3 shows a modulated sequence generation procedure according to an embodiment of the present disclosure.

FIG. 4 shows an example of a schematic diagram of a wireless terminal according to an embodiment of the present disclosure.

FIG. 5 shows an example of a schematic diagram of a wireless network node according to an embodiment of the present disclosure.

FIGS. 6 and 7 show flowcharts of methods according to some embodiments of the present disclosure.

### DETAILED DESCRIPTION

In some embodiments, the LP-WUS may be used to save the UE power consumption by providing a long sleep period and detecting the LP-WUS with a low power receiver. There are different kinds of indication information carried by the LP-WUS. When the number of indication information bits is increased, the resource occupation and power consumption may be increased. On the other hand, to save the UE power, a small signaling overhead may be used, which may cause the transmission performance being degraded.

Some embodiments of the present disclosure provide a trade-off between signaling overhead (e.g., the UE ID indication with 48 information bits) and transmission reliability (e.g., a target Block Error Rate, (BLER)=1%). Some embodiments of the present disclosure, particularly the sequence-based indication method, provide a solution for the dilemma described above.

In some embodiments of the present disclosure, an LP (low power) signal comprises at least one of a LP-SS (low power-synchronization signal), a LP-WUS (low power-wake-up signal) or the DCI (Downlink Control Information) carried by PDCCH (physical downlink control channel).

Some embodiments of the present disclosure are directed towards methods, systems and devices including the structure design of the LP signal (low power-wake-up signal) and the configuration process related to the LP signal.

In an embodiment the LP signal may be transmitted from a gNB (gNodeB) to a UE. In an embodiment, the indication information indicated/associated with the LP signal may include at least one of the following:
A wake-up indication. In an embodiment, the wake-up indication indicates whether to or not to wake up the main radio (MR), and/or wake up or not wake up the main radio for a time duration, and/or start or stop detecting the subsequent LP signal(s) for a time duration. In an embodiment, the time duration starts from the first slot or the first symbol after receiving the wake-up indication. In an embodiment, the time duration is configured by higher layer parameters.
An index information. In an embodiment, the index information indicates at least one of the cell ID, user equipment (UE) group ID, UE subgroup ID, UE ID, slot ID, subframe ID, or frame ID for the LP signal transmission.
Format information. In an embodiment, the format information indicates the type of the LP signal or the type of sequence that carries indication information of the LP signal which is detected by the UE.
System Information (SI) change information. In an embodiment, the SI change information indicates whether the SI changes or not, whether the UE needs to detect a PDCCH (physical downlink control channel) scheduling a SIB or not, or whether the UE needs to receive a System Information Block (SIB) or not.
Subcarrier spacing (SCS) information. In an embodiment, the SCS information indicates the numerology configuration (i.e., the subcarrier spacing) of the LP signal transmission for a time duration. In an embodiment, the time duration is the periodicity of the LP signal or LP-SS (low power synchronization signal), or the duration configured by a higher layer parameter, or the subsequent or current LP signal detected by the UE.
A transmission pattern. In an embodiment, the transmission pattern indicates at least one of the TDD (Time Division Duplex) pattern, the slot format, the symbol ID for the LP signal transmission/reception, indicates the slot format or the link direction of the symbol for the subsequent LP signal detection/receptions or for the subsequent one or more monitoring occasion, a cycle and/or an on duration for the LP signal reception.
The availability of the LP signal. In an embodiment, it indicates whether LP signal is available or transmitted or existed in a time duration or the subsequent one or more transmission occasions or monitoring occasions or not. Wherein the time duration is one or more LP signal cycle or LP signal transmission duration or the next N slots/symbols after the slot/symbol that receives the indication information.
Earthquake and Tsunami Warning System (ETWS) information or Commercial Mobile Alert System (CMAS) information. In an embodiment, the ETWS or CMAS information is contained in SIB7 and SIB8 respectively. This indication information may also indicate the change or notification of ETWS or CMAS information or the transmission of ETWS or CMAS information.

### Structure Design of LP Signal

In some embodiments, the LP signal may comprise at least one of the following types of structure:

In an embodiment, the first type of the LP signal comprises a sequence. In an embodiment, the sequence is generated by at least one of m-sequence, PN sequence, ZC sequence, SSS, PSS, Low peak-to-average-power ratio (low PAPR) sequence, the preamble, the time/frequency domain resource and/or the index information. In an embodiment, the sequence carries at least one of the indication information of the LP signal. In an embodiment, the sequence carries at least one of the cell ID information and/or wake-up indication.

In an embodiment, the information bits indicated by the first type of the LP signal may not be larger than M1 bits. M1 may not be smaller than Obit and is not larger than 10 bits. In an embodiment, the waveform is Cyclic Prefix Orthogonal Frequency Division Multiplex (CP-OFDM) and/or discrete Fourier Transform spread OFDM (DFT-s-OFDM).

In an embodiment, the SSS and PSS and low PAPR sequence is generated by a generation formula. In an embodiment, the ZC sequence is generated based on at least one of the base sequence, and/or m-sequence, and/or an initial value, and/or the SSS (Secondary Synchronization Signal), PSS (Primary Synchronization Signal), or Low PAPR sequence generation formula, and/or the index information, and/or the time/frequency domain resource. In an embodiment, the m-sequence includes at least one of the sequences used to generate the SSS, PSS, or PN sequence or NB-IoT WUS. In an embodiment, the index information is configured by higher layer information. In an embodiment, the time/frequency domain resource includes at least one of the slot ID, symbol ID, subframe ID, the type of band, the start of RB index, the frequency hopping configuration, the start of RB index of the Control Resource Set (CORESET), and/or the start time position of a periodicity for the LP signal transmission.

In an embodiment, the initial value of the m-sequence, PN sequence, the scrambling sequence, and/or the phase factor is determined by the time/frequency domain resource and/or the index information.

In an embodiment, the multiplexing mode among different information bits is Time Division Multiplex (TDM), Frequency Division Multiplex (FDM) and Code Division Multiplex (CDM). In an embodiment, the TDM is achieved by transmitting different sequences in the different symbol in one slot. In an embodiment, the FDM is achieved by transmitting different sequences in the different continuous Resource Blocks (RBs) and a guard band is used for two adjacent continuous RBs. In an embodiment, the CDM is achieved by transmitting one sequence and not transmitting other sequences in the sequence pool.

In an embodiment, the UE performs an RRM (Radio Resources Management) measurement, obtains time/frequency domain offset estimation information, and/or obtains synchronization information based on the first type of the LP signal.

In an embodiment, it is assumed that Ms is the length of the sequence and is in the range of [11, 132].

In the first example, the sequence is a ZC sequence (d). It may be generated by the following:

$$d ( n ) = {e}^{j θ n} \cdot r ( n )$$

$$n = 0 , 1 , ... , Ms - 1$$

Therein, ? is the phase factor and/or is determined by the generation formula of at least one of the m-sequence, PN sequence, a scrambling sequence, BPSK and QPSK and/or contains at least one of the values of [1, −1, 0, j, −j]. r(n) may be the base sequence, or

$$r ( n ) = {e}^{\frac{j π un ( n + 1 )}{Ms - 1}} , or {e}^{\frac{j π un ( n + 1 )}{Ms - 1}} {e}^{\frac{j 2 π gn}{Ms}} .$$

u may be determined by time/frequency domain resource, g may be determined by the index information.

In the second example, the sequence is a ZC sequence (d) which may be generated as follows:

$$d ( n ) = {e}^{j θ ( n ′ )} \cdot {e}^{\frac{j π um ( m + 1 )}{Ms - 1}} {e}^{\frac{j 2 π gn}{Ms}}$$

$$n = 0 , 1 , ... , Ms - 1$$

$${n}^{′} = n + Ms \cdot x$$

$$m = n mod Ms$$

Wherein, θ(n′) may be a phase factor and/or may be determined by at least an m-sequence, a PN sequence, a scrambling sequence, and/or a phase of BPSK or QPSK or 16QAM, and/or a spread sequence, and/or a Manchester code, and/or a predefined sequence (e.g., φ(n) of the low PAPR sequence generation type 1) and/or contains at least one of the values of [1, −1, 0, j, −j]. In an embodiment, x is the time/frequency domain resource for the LP signal transmission. In an embodiment, g is derived/determined by the index information.

In the third example, the sequence is an m-sequence (d) and may be generated as follows:

$$d ( n ) = [ 1 - {2}_{{X}_{0}} ( ( n + {m}_{0} ) mod Ms ) ] [ 1 - {2}_{{X}_{1}} ( ( n + {m}_{1} ) mod Ms ) ]$$

$${m}_{0} = 15 ⌊ \frac{{N}_{1}}{112} ⌋ + 5 {N}_{2} \cdot$$

$${m}_{1} = {N}_{1} mod 112$$

$$0 \leq n < Ms$$

wherein

$${x}_{0} ( i + 7 ) = ( {x}_{o} ( i + 4 ) + {x}_{0} ( i ) ) mod 2$$

$${x}_{1} ( i + 7 ) = ( {x}_{1} ( i + 4 ) + {x}_{1} ( i ) ) mod 2$$

and wherein

$$[ {x}_{0} ( 6 ) {x}_{0} ( 5 ) {x}_{0} ( 4 ) {x}_{0} ( 3 ) {x}_{0} ( 2 ) {x}_{0} ( 1 ) {x}_{0} ( 0 ) ] = [ \begin{matrix}0 & 0 & 0 & 0 & 0 & 0 & 1\end{matrix} ]$$

$$[ {x}_{1} ( 6 ) {x}_{1} ( 5 ) {x}_{1} ( 4 ) {x}_{1} ( 3 ) {x}_{1} ( 2 ) {x}_{1} ( 1 ) {x}_{1} ( 0 ) ] = [ \begin{matrix}0 & 0 & 0 & 0 & 0 & 0 & 1\end{matrix} ]$$

Wherein, Ms may be the length of the sequence d. In an embodiment, 11≤d≤127. In an embodiment, N₁ and N₂ are determined by the index information or the time/frequency domain resource occupied by the sequence, or the index of a UE or the index of a UE group or the cell ID is determined by N₁ and N₂.

In the fourth example, the sequence is a ZC sequence (d) which may be generated as follows:

$$d ( n ) = {θ}_{{n}_{f} , {n}_{s}} ( {n}^{′} ) \cdot {e}^{\frac{j π um ( m + 1 )}{Ms - 1}} {e}^{\frac{j 2 π gn}{Ms}}$$

$$n = 0 , 1 , … , Ms - 1$$

$${n}^{′} = n + Ms * x$$

$$m = n mod Ms$$

$${θ}_{{n}_{f} , {n}_{s}} ( {n}^{′} ) = \{ \begin{matrix}1 , if {c}_{{n}_{f} , {n}_{s}} ( 2 {n}^{′} ) = 0 and {c}_{{n}_{f} , {n}_{s}} ( 2 {n}^{′} + 1 ) = 0 \\ - 1 , if {c}_{{n}_{f} , {n}_{s}} ( 2 {n}^{′} ) = 0 and {c}_{{n}_{f} , {n}_{s}} ( 2 {n}^{′} + 1 ) = 1 \\ j , if {c}_{{n}_{f} , {n}_{s}} ( 2 {n}^{′} ) = 1 and {c}_{{n}_{f} , {n}_{s}} ( 2 {n}^{′} + 1 ) = 0 \\ - j , if {c}_{{n}_{f} , {n}_{s}} ( 2 {n}^{′} ) = 1 and {c}_{{n}_{f} , {n}_{s}} ( 2 {n}^{′} + 1 ) = 1\end{matrix}$$

$$u = ( {N}_{ID}^{Ncell} mod 126 ) + 3$$

In an embodiment, g is related to the LP signal transmission resource configuration and/or is determined by the UE group and/or is configured by higher layer parameter. In an embodiment, x is the subframe index that is configured by higher layer parameter. In an embodiment, cₙ_{_{f}}_{,n}_{ₛ}(2n′) is the scrambling sequence and the initial size of the scrambling sequence may be determined by the time domain resource configured for the LP signal transmission.

In the fifth example, the sequence is an m-sequence, and may be generated by the following:

$$d ( n ) = 1 - 2 x ( m )$$

$$m = ( n + 43 {N}_{2} ) mod Ms$$

$$0 \leq n < Ms$$

### Wherein

$$x ( i + 7 ) = ( x ( i + 4 ) + x ( i ) ) mod 2$$

$$and$$

$$[ x ( 6 ) x ( 5 ) x ( 4 ) x ( 3 ) x ( 2 ) x ( 1 ) x ( 0 ) ] = [ \begin{matrix}1 & 1 & 1 & 0 & 1 & 1 & 0\end{matrix} ]$$

In an embodiment, Ms is the length of the sequence d. In an embodiment, 11≤d≤127. In an embodiment, N₂ is determined by the index information or the time/frequency domain resource occupied by the sequence, or the index of a UE or the index of a UE group or the cell ID is determined by N₂.

For example, the first type of the LP signal is a sequence carrying 1, 2, or 3 bits of information. The function comprises at least one of the RRM measurement, and/or time/frequency error/offset estimation, cell identify, synchronization and/or carrying a subset of indication information of the LP signal. The waveform includes CP-OFDM or DFT-s-OFDM waveform.

For example, the first type of the LP signal is an LP SS. The function comprises at least one of the RRM measurement, and/or time/frequency error/offset estimation, and/or cell identify, and/or synchronization.

In an embodiment, when the sequence carries indication information of the availability of the LP signal and/or transmission pattern and/or the time/frequency domain resource information (e.g., frame index, subframe index, slot index, symbol index and/or the start/end of RB index), it can provide a lower Forwarding Action Rule (FAR) and a higher detection reliability for the subsequent LP signal detection.

In an embodiment, the second type of the LP signal comprises a modulated and/or coded sequence. In an embodiment, the sequence indicates a subset of the content of the LP signal. In an embodiment, the second type of the LP signal indicates a subset of the content of the LP signal. In an embodiment, the indicated information bits are processed by a modulator and/or an encoder. In an embodiment, the modulated sequence is mapped into physical resource according to the configuration for the LP signal transmission. In an embodiment, the modulator modulates the information bits by at least one of a sequence, OOK modulation, FSK modulation, a ZC sequence and/or long/short low PAPR sequence. In an embodiment, the number of PRBs (physical resource blocks) occupied by a single modulated sequence is not smaller than 3 and is not larger than 11. In an embodiment, the sequence is generated by at least one of the generation formulas in the above embodiments. In an embodiment, the length of a short low PAPR sequence is less than 30.

In an embodiment, the information bits indicated by the second type of the LP signal may be M2 bits. In an embodiment, M2 may not be less than 2 bits and not larger than 256 bits. In an embodiment, the waveform is CP-OFDM and/or DFT-s-OFDM.

For example, the second type of the LP signal comprises a ZC sequence. One ZC sequence indicates 1 bit information. The number of information bit (e.g., M2) is not larger than 8. In some embodiments, each bit of the M2 information bits corresponds to the information indicating an index information, e.g., a UE group ID or UE subgroup ID. In some embodiments, it needs 2M2 candidate ZC sequences to indicate M2-bit information, i.e., two sequences used for 1 bit information indication. In some embodiments, it needs M2 candidate ZC sequences to indicate M2-bit information, i.e., one sequence used for 1 bit information indication.

In an embodiment, the multiplexing mode among different information bits is TDM, FDM and CDM.

In an embodiment, the TDM is achieved by transmitting one or more sequences in different time. In an embodiment, the one or more sequences is/are mapped into different symbols in one slot or multiple slots repeatedly or respectively.

In an embodiment, the FDM is achieved by transmitting one or more sequences in different RBs. In an embodiment, the one or more sequences is/are mapped into different continuous RBs repeatedly or respectively. In an embodiment, the different continuous RBs belong to a same band or different bands and/or correspond to a same slot/symbol or different slots/symbols. In an embodiment, a guard band is used for two adjacent continuous RBs or the different bands. In an embodiment, the band is an NR band or an LTE band or a narrow band.

In an embodiment, the CDM is achieved by transmitting one sequence and not transmitting other sequences at the same time and/or transmitting multiple sequences by a spread sequence or orthogonality cover code (OCC) sequence or RM code or polar code.

In the following paragraphs, it is assumed that Ms is the length of the sequence and is in the range of [23, 127].

In the first example, the second type of the LP signal comprises a modulated sequence generated by the OOK modulation. The size of information carried by the modulated sequence is not smaller than 10 bits or 20 bits. The indication information indicated by the second type of the LP signal includes at least one of the index information (e.g., the UE ID and/or UE group ID information) and the indication information of the LP signal. The waveform of the second type of the LP signal comprises a OOK waveform.

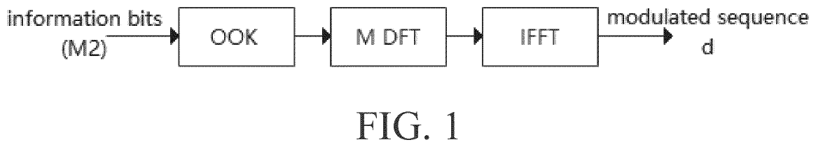

FIG. 1 shows a modulated sequence generation procedure according to an embodiment.

In an embodiment, the step of the OOK modulation includes a up sampling and/or a code and/or multiplying a phase sequence. Wherein the code includes at least one of: the spread code and/or a Manchester code and/or RM code and/or a polar code. In an embodiment, the phase sequence includes at least one of a random sequence with [1-1], a Gaussian sequence, or BPSK or QPSK or 16QAM or 64QAM.

In an embodiment, the step of M DFT includes a M-point DFT-s-OFDM process and/or mapping into physical resource. In an embodiment, M is not larger than the length of the output of OOK process.

In an embodiment, the step of IFFT is OFDM modulation that is transform the sequence from frequency domain into time domain.

In an embodiment, LP signal is generated by OOK modulation by using the following steps:

Assume that the following steps generate M continuous OOK symbols, wherein M is not less than 1.

Firstly, the M continuous OOK symbols carries M bits information S_{M}. Define S_{M}=[s₀, s₁, s₂, s₃ . . . , s_{M-1}].

Secondly, transform S_{M} into Q_{K} according to the following formula. Wherein the length of Q_{K} is equal to K.

$${Q}_{K} = [ {\underbrace{{s}_{0} , {s}_{0} , … , {s}_{0} ,}}_{A} {\underbrace{{s}_{1} , {s}_{1} , … , {s}_{1} ,}}_{A} … , {\underbrace{{s}_{M - 1} , {s}_{M - 1} , … , {s}_{M - 1}}}_{A} ] , or$$

$${Q}_{K} = [ {\underbrace{{w}_{0}^{0} \cdot {s}_{0} , {w}_{0}^{1} \cdot {s}_{0} , … , {w}_{0}^{{A}_{0} - 1} \cdot {s}_{0} ,}}_{A} {\underbrace{{w}_{1}^{0} \cdot {s}_{1} , {w}_{1}^{1} \cdot {s}_{1} , … , {w}_{1}^{{A}_{1} - 1} \cdot {s}_{1} ,}}_{A} … , {\underbrace{{w}_{M - 1}^{0} \cdot {s}_{M - 1} , {w}_{M - 1}^{1} \cdot {s}_{M - 1} , … , {w}_{M - 1}^{{A}_{M - 1}} \cdot {s}_{M - 1}}}_{A} ]$$

Wherein A₀+A₁+ . . . Aᵢ+ . . . +A_{M-1}=K

Wherein the sequence

$${w}_{i}^{0} , {w}_{i}^{1} , … , {w}_{i}^{{A}_{i} - 1}$$

can be configured by higher layer parameters. Wherein 0≤i≤M−1.

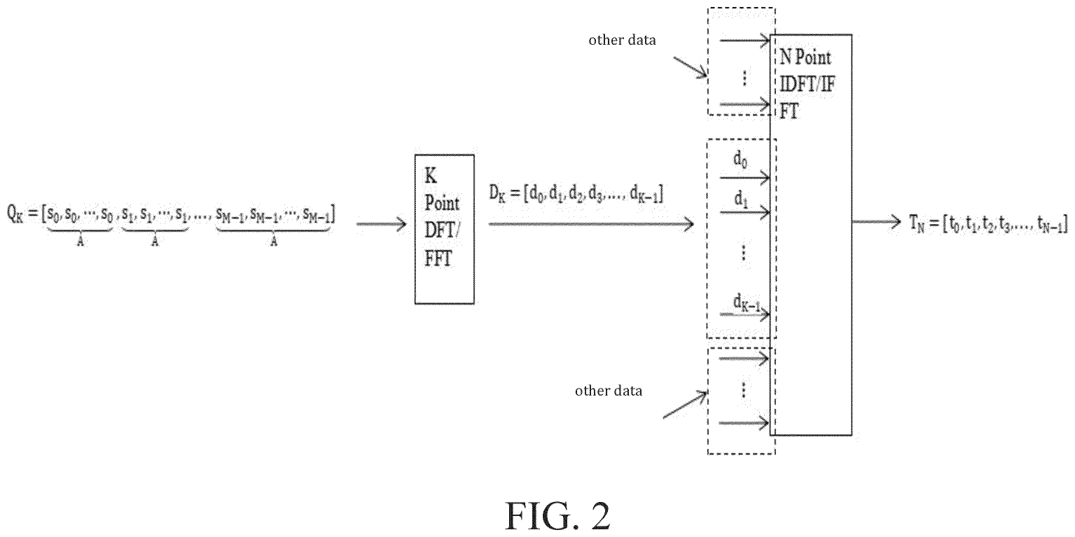

Then, process Q_{K} as following steps (see FIG. 2):

Process Q_K by K point DFT/FFT to obtain sequence/data D_{K}=[d₀, d₁, d₂, d₃, . . . , d_{K-1}];

Map the sequence/data D_{K} into the K subcarriers in the frequence domain resource for the LP signal transmission;

When the system frequency band includes N subcarriers, fill data into N subcarriers and perform N point IDFT/IFFT process, and then obtain time domain data T_{N}=[t₀, t₁, t₂, t₃, . . . , t_{N-1}], wherein T_{N}=[t₀, t₁, t₂, t₃, . . . , t_{N-1}] is M OOK time domain symbols which is a sampled data. Wherein

$$[ {t}_{0} , {t}_{1} , {t}_{2} , {t}_{3} , … , {t}_{\frac{N}{M} - 1} ]$$

is the first OOK symbol of the M OOK symbols. Wherein

$$[ {t}_{\frac{N}{M}} , {t}_{\frac{N}{M} + 1} , … , {t}_{\frac{2 N}{M} - 1} ]$$

is the second OOK symbol of the M OOK symbols. It easy to obtain that

$$[ {t}_{\frac{( M - 1 ) N}{M}} , {t}_{\frac{( M - 1 ) N}{M} + 1} , … , {t}_{N - 1} ]$$

is the M-th OOK symbol of the M OOK symbols.

Finally, add Cyclic prefix (CP) to OOK time domain symbols and then transmit N time domain data T_{N}=[t₀, t₁, t₂, t₃, . . . , t_{N-1}]. In an embodiment, the step of ‘add CP’ includes at least one of copying the end of Ncp symbols of T_{N} to the head of T_{N}, then generating (N+Ncp) time domain data, then transmitting (N+Ncp) time domain data.

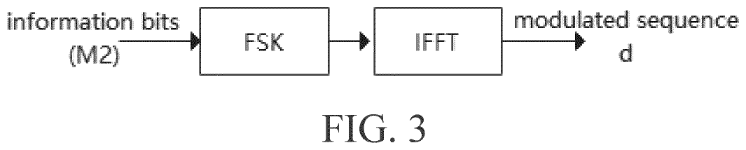

In the second example, the sequence is generated by FSK modulation by using the following steps (see FIG. 3).

In an embodiment, a waveform is generated by modulating sub-carriers of CP-OFDM symbol. In an embodiment, subcarriers carry the sequence that is the information bits modulated by FSK.

In an embodiment, the step of FSK includes at least one of an up sampling and/or a code and/or multiplying a phase sequence. In an embodiment, the code includes at least one of the spread code and/or a Manchester code and/or RM code and/or a polar code. In an embodiment, the phase sequence includes at least one of a random sequence with [1 −1], a Gaussian sequence, or BPSK or QPSK or 16QAM or 64QAM.

In the third example, the sequence is generated by short low PAPR sequence.

The low-PAPR sequence

$${r}_{u , v}^{( a , δ )}$$

may be defined by a base sequence r̅_{u,v}(n) according to

$${r}_{u , v}^{( a , δ )} ( n ) = {\overline{r}}_{u , v} ( n ) , 0 \leq n < Ms$$

where

$$Ms = {mN}_{sc}^{RB} / {2}^{δ}$$

is the length of the sequence.

Base sequences r̅_{u,v}(n) may be divided into groups, where u∈{0,1, . . . , 29} is the group number and v is the base sequence number within the group, such that each group contains one base sequence (v=0) of length

$$Ms = {mN}_{sc}^{RB} / {2}^{δ} , 1 / 2 \leq m / {2}^{δ} .$$

The sequence r̅_{u,v}(0), . . . , r̅_{u,v}(Ms−1) may be defined by

$${\overline{r}}_{u , v} ( n ) = \frac{1}{\sqrt{Ms}} {\sum }_{i = 0}^{Ms - 1} {\overline{r}}_{u , v} ( i ) {e}^{- j \frac{2 π in}{MS}}$$

$$n = 0 , … , Ms - 1$$

where the definition of \tilde{r}_{u,v}(i) may depend on the sequence length.
the sequence \tilde{r}_{u,v}(i) may be given by

$${\tilde{r}}_{u , v} ( i ) = {e}^{j φ ( i ) π / 8} , 0 \leq i \leq Ms - 1$$

where the value of φ(i) is predefined or configured by higher layer parameters.

In an embodiment, the sequences with TDM correspond to a different UE group for indicating the content of the LP signal.

In the fourth example, the second type of the LP signal comprising a sequence which is generated by at least one of a ZC sequence, a PN sequence, the UE group ID, the PO index or the time/frequency domain resource. The size of information carried by the sequence is not larger than 8 bits. The indication information indicated by the second type of the LP signal includes at least one of the indication information of the LP signal except for the index information. The waveform of the second type of the LP signal comprises a CP-OFDM waveform.

In an embodiment, after generating a sequence, the sequence is processed by Manchester code. It can ensure a lower FAR and provide a higher detection reliability.

In an embodiment, the third type of the LP signal comprises a data. In an embodiment, the data carries a subset of the content of the LP signal.

In an embodiment, the information bits indicated by the third type of the LP signal is M3 bits. In an embodiment, M3 is not smaller than 2 bits and is not larger than 256 bits. In an embodiment, the waveform is CP-OFDM and/or DFT-s-OFDM.

In an embodiment, the process procedure of the data includes OOK, FSK, BPSK (Binary Phase Shift Keying), or QPSK (Quadrature Phase Shift Keying) modulation and/or scrambling by a sequence and/or the Manchester code and/or RM code and/or polar code and/or a sequence-based modulation. In an embodiment, the sequence includes the sequences disclosed in the first/second type of the LP signal.

In an embodiment, the position of a Demodulation Reference Signal (DMRS) and data is TDM. In an embodiment, DMRS is located before or after the symbol of the data.

In some embodiments, the third type of the LP signal comprises a modulated sequence generated by the OOK modulation and one of the Manchester code, RM code and polar code. The size of information carried by the modulated and/or coded sequence is not smaller than 10 bits. The indication information indicated by the third type of the LP signal includes at least one of the index information (e.g., the UE ID and/or UE group ID information) and the indication information of the LP signal. The waveform of the third type of the LP signal comprises a OOK waveform and/or CP-a OFDM waveform.

In an embodiment, the fourth type of the LP signal comprises a data. In an embodiment, the data carries/indicates a subset of the content of the LP signal.

In an embodiment, the information bits indicated by the fourth type of the LP signal is M4. In an embodiment, M4 is not smaller than 2 bits and is not larger than 256 bits. In an embodiment, the waveform is CP-OFDM and/or DFT-s-OFDM.

In an embodiment, the process procedure of the data includes convolutional code/polar code/Manchester code, OOK, FSK, BPSK, or QPSK modulation, and/or scrambling by a sequence and/or a sequence-based modulation.

In an embodiment, the position of DMRS and data is FDM. For example, DMRS is located before or after the subcarrier of the data.

In an embodiment, the fifth type of the LP signal comprises any two or more of the first type of the LP signal, the second type of the LP signal, the third type of the LP signal, the fourth type of the LP signal and the fifth type of the LP signal; wherein the fifth signal format comprises at least one of the first type of the LP signal, the second type of the LP signal, or one of the third and fourth type of the LP signal.

In the first example, the fifth type of the LP signal comprises the first type of the LP signal and the second type of the LP signal is TDM and/or FDM and/or CDM. In an embodiment, a time gap or guard band is located between the third type of the LP signal and the first/second type of the LP signal. In an embodiment, the guard band is in the unit of subcarrier or RB and/or is predefined or configured by higher layer parameter. In an embodiment, the time gap is in the unit of symbol/slot and/or is predefined or configured by higher layer parameter.

In the second example, the fifth type of the LP signal comprises the first/second type of the LP signal and the third/fourth type of the LP signal. In an embodiment, the first/second type of the LP signal indicates at least one of the wake-up indication, the index information, and/or the time/frequency domain resource of the LP signal. In an embodiment, the third/fourth type of the LP signal indicates the subset of the content of the LP signal.

In an embodiment, the first/second type of the LP signal and the third/fourth type of the LP signal is TDM. In an embodiment, a time gap is located between the third/fourth type of the LP signal and the first/second type of the LP signal and the time gap is in the unit of symbol/slot and/or is predefined or configured by higher layer parameter.

In the third example, the fifth type of the LP signal comprises at least one of the first type of the LP signal, the second type of the LP signal and the third/fourth type of the LP signal. In an embodiment, the first type of the LP signal indicates the time/frequency domain resource of the LP signal. In an embodiment, the second type of the LP signal indicates the first subset of the content of the LP signal. In an embodiment, the third/fourth type of the LP signal indicates the second subset of the content of the LP signal.

In an embodiment, the first subset of the content of the LP signal includes at least one of the wake-up indication, index information, ETWS/CMAS information, SI change information and the SCS information. In an embodiment, the second subset of the content of the LP signal includes at least one of the wake-up indication, index information, the ETWS/CMAS information, SI change information and the format information.

In an embodiment, the first type of the LP signal and the second type of the LP signal is TDM and/or FDM and/or CDM. In an embodiment, the third type of the LP signal and the first/second type of the LP signal is TDM. In an embodiment, a time gap is located between the third type of the LP signal and the first/second type of the LP signal and the time gap is in the unit of symbol/slot and/or is predefined or configured by higher layer parameter.

In an embodiment, the sixth type of the LP signal comprises a Physical Downlink Control Channel (PDCCH). In an embodiment, the PDCCH carrying the Downlink Control Information (DCI) format 2_7 or a new DCI format. In an embodiment, the PDCCH indicates a subset of the content of the LP signal. In an embodiment, the information bits indicated by the second type of the LP signal is not smaller than M8 bits, in which M8 is an integer not less than 1.

In an embodiment, the UE monitors the sixth type of the LP signal after the reception of wake-up indication which indicates the UE to wake-up the MR.

In an embodiment, after detection of the wake-up indication which indicates the UE to wake-up the MR, the UE starts monitoring the sixth type of the LP signal.

In an embodiment, the subset of the content of the LP signal includes at least one of the wake-up indication, index information, ETWS/CMAS information and SI change information.

In an embodiment, when the content of the LP signal is Format Information and the Type of the LP signal is the first type, triggering states may include at least one of the following:

Detection of the sequence 0 indicates that the first type of the LP signal is transmitted in the subsequent time duration. Detection of the sequence 1 indicates that the second type of the LP signal is transmitted in the subsequent time/frequency domain resource. Detection of the sequence 2 indicates that the third type of the LP signal is transmitted in the subsequent time/frequency domain resource. If the UE does not detect the sequence, it indicates that the type of the LP signal corresponding to the sequence is not required or transmitted in the subsequent time/frequency domain resource.

In an embodiment, when the content of the LP signal is Index Information or Wake-up Indication and the Type of the LP signal is the second type or the sixth type, triggering states may include at least one of the following:

In an embodiment, there are N sequences and each sequence indicates an index information. N is an integer. In an embodiment, the length of index information is not larger than M2 bits.

In an embodiment, detection of one sequence indicates a cell ID, UE group ID, UE subgroup ID and/or UE ID, and indicates the UE to wake up the MR.

In an embodiment, if the UE does not detect any sequence, the UE does not wake up the MR.

In an embodiment, the indication information of the LP signal exception for the index information and wake-up indication is indicated by DCI carried by a PDCCH. There is a number of blocks in the DCI and each block indicates the information for a UE or a UE group.

In an embodiment, when the content of the LP signal is ETWS/CMAS information, SI change information or SCS information and the Type of the LP signal is the third type or the fourth type, triggering states may include at least one of the following:

If the UE is provided with a higher layer parameter related to the LP signal, the UE determines the ETWS/CMAS information, SI change information, SCS information according to the configuration of higher layer parameters for the LP signal transmission.

In an embodiment, the configuration procedure of the LP signal comprises at least one of the following:

In an embodiment, the resource allocation of the LP signal is configured by a resource set. In an embodiment, the resource set with a resource set ID can be configured by a UE-specific higher layer parameter and/or configured by a SIB for a group of UEs. In an embodiment, the SIB is at least one of the SIB1, SIB17 or a new SIB for the LP signal configuration. In an embodiment, a maximum number of resources in a resource set is configured by a higher layer parameter.

In an embodiment, the parameters in the resource of the LP signal includes at least one of the following:

The number of UE subgroups and/or the number of UE groups and/or the number of UEs.

Payload size for the first, second, third, fourth, fifth, and/or sixth type of the LP signal.

Format information. In an embodiment, the type of the LP signal includes at least one of the first, second, third, fourth, fifth, and/or sixth type of the LP signal. In an embodiment, the type of the LP signal is the format of the LP signal.

Cycle shift. In an embodiment, the cycle shift corresponds to a UE or a UE group. In an embodiment, the cycle shift corresponds to a content or a triggering state for the LP signal.

Search Space. In an embodiment, the search space is used to determine the monitoring occasions for the LP signal.

Frame Offset to determine the start of monitoring occasion for the LP signal.

First monitoring occasion for the LP signal. In an embodiment, the first monitoring occasion for the LP signal is used to detect or transmit the first or second type of the LP signal.

The start PRB index and/or the number of PRB(s) and/or PRB offset. In an embodiment, the start PRB index and/or the number of PRB and/or the PRB offset is used to determine the PRBs for the LP signal transmission. In an embodiment, the PRBs are located in the initial BWP or a guard band or the active DL BWP. In an embodiment, the initial BWP is configured by a SIB.

Time domain resource information. In an embodiment, the time domain resource information includes at least one of the number of frame, subframe, slot, or symbol and/or the start frame ID and/or subframe ID and/or slot ID and/or symbol ID. In an embodiment, the frame ID, subframe ID, slot ID, or symbol ID is used for the LP signal transmission.

OCC index. In an embodiment, the OCC index is used for DMRS or sequence in time domain or frequency domain for a UE or a UE group.

Sequence index. In an embodiment, the sequence index corresponds to the entry in the sequence pool and/or is used to determine the initial value of the sequence generation formula.

In an embodiment, the cycle shift, the Search Space, the frame offset, the first monitoring occasion for the LP signal, the start PRB index, the number of PRB, the PRB offset, the time domain resource information, the OCC index, the sequence index described above include the time domain and frequency domain resource and sequence information for the LP signal transmission and detection.

In an embodiment, the configuration method of index information including UE ID and/or UE group ID and/or UE subgroup ID includes at least one of the following:

In an embodiment, index information is configured by RRC release configuration.

In an embodiment, index information is assigned by CN for the UE supporting LP signal receiver (LP-WUR).

In an embodiment, a UE ID represents the order index of the UE among all of the UEs supporting LP signal receiver (LP-WUR). In an embodiment, the index information is indicated or configured by higher layer parameters or carried by the corresponding sequence ID.

In an embodiment, a UE group ID and/or UE subgroup ID is determined by UE ID for the UE supporting LP signal receiver (LP-WUR).

In an embodiment, the UE grouping may be based on mobility speed. In an embodiment, the UEs in a same range of mobility speed are grouped into a UE group/UE subgroup.

In an embodiment, the UE grouping based on a paging rate may include at least one of the following steps:
1) UEs without paging rate are grouped into one group.
2) UEs in a same range of paging rate are grouped into one group. In an embodiment, the difference between the maximum value and the minimum value in the range of paging rate is less than a threshold.
3) UEs with a difference of paging rate larger than a threshold are not grouped into one group.

Table 1 shows UE grouping according to an embodiment.

| | | UE group index in UE groups list | |
|---|---|---|---|
| UE group set | probThreshList | Lower bound | Upper bound |
| 1 | P ≤ Thresh1 | 0 | Nₜₕ₁ − 1 |
| 2 | Thresh₁ < P ≤ Thresh₂ (Note) | Nₜₕ₁ | Nₜₕ₁ + Nₜₕ₂ − 1 |
| 3 | Thresh₂ < P ≤ Thresh₃ (Note) | Nₜₕ₁ + Nₜₕ₂ | Nₜₕ₁ + Nₜₕ₂ + Nₜₕ₃ − 1 |
| 4 | P > Thresh₃ | Nₜₕ₁ + Nₜₕ₂ + Nₜₕ₃ | Max_UE_group − 1 |

wherein
Threshi is a value signalled in the i^{th} entry of the list of probability threshold, i.e. probThreshList
Nₜₕᵢ is the value signalled in the i^{th} entry of the list of UE groups for service
In an embodiment, when the total number of WUS group sets is less than 4, the upper bound for the WUS group set with highest index may be Max_UE_group − 1.

In an embodiment, the UE group based on UE ID is determined by at least one of the following methods:

In an embodiment, if the UE is not configured with a CN assigned subgroup ID, or if the UE configured with a CN assigned subgroup ID is in a cell supporting only UE_ID based subgrouping, the subgroup ID of the UE may be determined by the formula below:

$$SubgroupID = ( floor ( UE\_ID / ( N * Ns ) ) mod subgroupsNumForUEID ) + ( subgroupsNumPerPO - subgroupsNumForUEID ) ,$$

Wherein:

N: number of monitoring occasions in T, and/or number of total paging frames in T, and/or number of the LP signal monitoring occasions in T. In an embodiment, T is the DRX cycle of RRC_IDLE state or the periodicity for the LP signal transmission.

Ns: number of the LP signal monitoring occasions in a periodicity, and/or number of paging occasions for a PF.

UE_ID: 5G-S-TMSI mod X, where X is 32768, if eDRX is applied; otherwise, X is 8192.

subgroupsNumForUEID: number of subgroups for UE_ID based subgrouping in a periodicity or a LP signal MO or a PO, which is broadcasted in system information.

In an embodiment, a UE supporting CN assigned grouping in RRC_IDLE or RRC INACTIVE state can be assigned a group ID by AMF through NAS signaling.

In an embodiment, the UE group includes one or more UE subgroups.

In an embodiment, a UE in RRC connected mode is provided by the time/frequency domain resource and sequence information which are configured by a UE-specific higher layer parameter in a first cell. In an embodiment, if the UE is in RRC idle mode, the UE may detect LP signal according to the configuration by UE-specific higher layer parameter when the UE stays in the first cell. The UE may detect LP signal according to legacy behavior when the UE stays in a cell which is different from the first cell. In an embodiment, the legacy behavior includes at least one of the blind detection of the LP signal or detection of the LP signal by MR or detection of the LP signal after receiving the configuration by higher layer parameter.

In an embodiment, the type of the LP signal is determined based on at least one of the following parameters:
the indication of the type of the LP signal;
the length of information bits carried by the LP signal;
the number of PRB for the LP signal transmission;
the number of slots for the LP signal transmission;
the length of time duration for the LP signal detection;
the EPRE value;
the waveform;
the band;
the sequence generation formula;
the DMRS position;
the UE capabilities/UE type;
the wake-up indication method, such as UE-specific wake-up indication, group based wake-up indication;
the information type, e.g., wake-up indication carried by OOK, SI change/ETWS carried by sequence;
the operation mode of the LP signal, e.g., in band, guard band, out band, stand alone or non-stand alone;
the TDD/FDD;
the licensed/unlicensed band;
the coverage level;
the application scenario, e.g., enhanced Mobile Broadband (eMBB), Ultra Reliability Low Latency (URLLC), massive Machine Type Communication (mMTC), NB-IoT, etc.
the link direction, e.g., uplink, downlink, SUL, IAB link, and sidelink, etc.
the length of sequence used to generate LP signal or indicate indication information of the LP signal;
the value of rate (e.g., the code rate or the transmission rate/efficiency);
the encoding type;
the aggregation level (AL) of Control Channel Element (CCE);
the search space type;
the number of transmission for a sequence/data/LP signal;
the channel state information (CSI) process;
the frame number that carries the LP signal;
the location index of cyclic redundancy check bits/truncation bits in the sequence processed by modulation or code or DFT (discrete Fourier transform); and/or
the carrier frequency which carries LP signal, e.g., 4 GHZ, 2.6 GHz and 700 MHz.

In some embodiments, the type of the LP signal is determined by the type of LP signal or format information configured by higher layer parameter or indicated by other type of LP signal.

In some embodiments, the length of information bits carried by the type of LP signal is the size of information. In some embodiments, if the size of information is in a first range, the first type of LP signal is detected by the UE; and/or if the size of information is in a second range, the second type of LP signal is detected by the UE; and/or if the size of information is in a third range, the third type of LP signal is detected by the UE; and/or if the size of information is in a fourth range, the fourth type of LP signal is detected by the UE; and/or if the size of information is in a fifth range, the fifth type of LP signal is detected by the UE; and/or if the size of information is in a sixth range, the sixth type of LP signal is detected by the UE. In some embodiments, the maximum value in the first/second range is not larger than 10 bits, and/or the minimum value of the first/second range is not smaller than 1 bit. In some embodiments, the maximum value in the third/fourth/fifth range is not larger than 256bits, and/or the minimum value of the third/fourth/fifth range is not smaller than 1 bit. In some embodiments, the maximum value in the sixth range is not smaller than 128bits, and/or the minimum value of the sixth range is not smaller than 4 bits.

In some embodiments, the number of the PRB/the band width configured for the first or second type of LP signal is in the first range; and/or the number of the PRB/the band width configured for the first or third or fourth or fifth type of LP signal is in the second range; and/or the number of the PRB/the band width configured for the sixth type of LP signal is in the third range. In some embodiments, the first range includes at least the number of the PRB/band width that is not larger than 12 RBs/5 MHz. In some embodiments, the second range includes at least the number of the PRB/band width that is not smaller than 12 RBs/5 MHz. In some embodiments, the third range includes at least the number of the PRB/band width of a control resource set CORESET that is configured by higher layer parameter.

In some embodiments, the first/second type of LP signal occupies a first number of slots; and/or the third/fourth/fifth type of LP signal occupies a second number of slots; and/or the sixth type of LP signal occupies a third number of slots. In some embodiments, the first number of slots includes at least 1, 2, 3, or 4 continuous slots. In some embodiments, the second number of slots includes at least 1 to 16 continuous slots. In some embodiments, the third number of slots includes at least 1 to 64 continuous slots.

In some embodiments, the UE detects the first/second type of LP signal during a first length of time duration; and/or the UE detects the third/fourth/fifth type of LP signal during a second length of time duration; and/or the UE detects the sixth type of LP signal during a third length of time duration. In some embodiments,

In some embodiments, the UE detects the first type of LP signal if EPRE value in the first range; and/or the UE detects the second type of LP signal if EPRE value in the second range; and/or the UE detects the third type of LP signal if EPRE value in the third range; and/or the UE detects the fourth type of LP signal if EPRE value in the fourth range; and/or the UE detects the fifth type of LP signal if EPRE value in the fifth range; and/or the UE detects the sixth type of LP signal if EPRE value in the sixth range. Wherein the first range/second range is in a unit of symbol/slot. Wherein the third/fourth/fifth range is in a unit of slot. Wherein the sixth range is in a unit of slot/millisecond.

In some embodiments, the UE detects the first/second/third/fourth/fifth/sixth type of LP signal if the UE supports the capability of detection of first/second/third/fourth/fifth/sixth type of LP signal. In some embodiments, the UE detects the first/second/third/fourth/fifth/sixth type of LP signal if the UE includes at least one of a narrow band internet of thing, NB IoT, device, a wearable device, a low power receiver or a reduced capability, RedCap, device.

In some embodiments, the first/second/third/fourth/fifth type of LP signal is used to indicate the wake-up indication for a group of UE; and/or the sixth type of LP signal is used to indicate the wake-up indication for a UE.

In some embodiments, the operation mode of the first/second/third/fourth/fifth/sixth type of LP signal corresponds to the first/second/third/fourth/fifth/sixth operation method. In some embodiments, the first/second/third/fourth operation mode includes at least one of the operations in guard band, out band, or stand alone. In some embodiments, the sixth operation mode includes at least one of the operations in band, guard band or non-stand alone.

In some embodiments, UE detects the first/second/third/fourth/fifth type of LP signal with TDD; and/or UE detects the third/fourth/fifth/sixth type of LP signal with TDD and/or FDD.

In some embodiments, the detection or transmission of the first/second/third/fourth/fifth type of LP signal is processed in at least one of the licensed band or the unlicensed band. In some embodiments, the detection or transmission of fifth/sixth type of LP signal is processed in the licensed band.

In some embodiments, the UE detects the first type of LP signal in the first range of coverage level; and/or the UE detects the second type of LP signal in the second range of coverage level; and/or the UE detects the third type of LP signal in the third range of coverage level; and/or the UE detects the fourth type of LP signal in the fourth range of coverage level; and/or the UE detects the fifth type of LP signal in the fifth range of coverage level; and/or the UE detects the sixth type of LP signal in the sixth range of coverage level. In some embodiments, the first range of coverage level is not lower than at least one of the second/third/fourth/fifth/sixth range of coverage level.

In some embodiments, the first/second/third/fourth/fifth/sixth type of LP signal is detected by the first/second/third/fourth/fifth/sixth application scenario. In some embodiments, first/second/third/fourth/fifth/sixth application scenario includes at least one of the enhanced Mobile Broadband (eMBB), Ultra Reliability Low Latency (URLLC), massive Machine Type Communication (mMTC), NB-IoT, etc.

In some embodiments, the first/second/third/fourth/fifth/sixth type of LP signal is detected by the first/second/third/fourth/fifth/sixth link direction. In some embodiments, the first or second or fifth link direction includes at least one of the downlink, IAB link or sidelink. In some embodiments, the third or fourth or sixth link direction includes at least one of the uplink, supplemented uplink, SUL, downlink, IAB link or sidelink, etc.

In some embodiments, the first/second/third/fourth/fifth/sixth type of LP signal is transmitted with the first/second/third/fourth/fifth/sixth rate. In some embodiments, the first rate is less than at least one of the second/third/fourth/fifth/sixth rate. In some embodiments, the second/third/fourth/fifth rate is not larger than 1/2. In some embodiments, the sixth rate includes at least one of the rate in the modulation and coding scheme, in the MCS table and/or is not larger than 0.95. In some embodiments, the value of rate includes at least one of the code rate, or the transmission rate, or the spectrum efficiency.

In some embodiments, the first/second/third/fourth/fifth/sixth type of LP signal is transmitted with the first/second/third/fourth/fifth/sixth AL. In some embodiments, the first/second/third/fourth AL is not larger than 2 and/or is not less than 1. In some embodiments, the fifth/sixth AL is not larger than 16. Wherein the AL includes at least one of the aggregation level (AL) of Control Channel Element (CCE), or the number of continuous CCE.

In some embodiments, the UE detects the first type of LP signal according to the first search space type; and/or the UE detects the second type of LP signal according to the second search space type; and/or the UE detects the third type of LP signal according to the third search space type; and/or the UE detects the fourth type of LP signal according to the fourth search space type; and/or the UE detects the fifth type of LP signal according to the fifth search space type; and/or the UE detects the sixth type of LP signal according to the sixth search space type. Wherein the sixth search space type includes at least one of the UE specific search space set and/or Type-0/Type-2/Type-2A/Type-3 common search space.

In some embodiments, the first/second/third/fourth/fifth/sixth type of LP signal is transmitted with the first/second/third/fourth/fifth/sixth number of sequence/data/LP signal. In some embodiments, the first/second number of sequence/data/LP signal is not larger than 16. In some embodiments, the third/fourth/fifth number of sequence/data/LP signal is not less than 2. In some embodiments, the fifth/sixth number of sequence/data/LP signal is not less than 1 and is not larger than 16.

In some embodiments, the first/second/third/fourth/fifth/sixth type of LP signal is transmitted with the first/second/third/fourth/fifth/sixth channel state information (CSI) process.

In some embodiments, the location index of cyclic redundancy check bits/truncation bits in the sequence processed by modulation or code or DFT (discrete Fourier transform) of the first/second/third/fourth/fifth/sixth type of LP signal includes at least one of the end/start of modulated/coded LP signal or the configured index.

In some embodiments, the first/second/third/fourth/fifth/sixth type of LP signal is transmitted with the first/second/third/fourth/fifth/sixth carrier. In some embodiments, the second/third/fourth carrier frequency includes at least one of 2.6 GHz or 700 MHz. In some embodiments, the first/fifth/sixth carrier frequency includes at least one of 4 GHz, 2.6 GHz or 700 MHz.

### Fall Back-Mechanism of Detection of the LP Signal

In some embodiments, the receiver (e.g., in the UE) comprises: a OOK receiver receiving a signal with a OOK waveform, a simplified receiver receiving a signal with OFDM waveform, a simplified receiver with a low accuracy component, a legacy receiver, or a MR.

In some embodiments, the first wireless communication node (e.g., the UE) stops receiving a first LP signal or stops using a first receiver (e.g., in the UE) to receive a LP signal during a first allocated resource if at least one of the following first conditions are satisfied:
the first LP signal does not be detected during a time duration;
the first LP signal does not be detected by using the first receiver;
the first LP signal does not be detected during a time duration during a time duration;
the first LP signal indicates a wake-up indication;
the first LP signal indicates a wake-up indication by using the first receiver; and/or
the first LP signal indicates a not wake-up indication by using the second receiver (e.g., in the UE).

In some embodiments, the first wireless communication node starts receiving a first LP signal or a second LP signal and/or starts using a second receiver to receive a LP signal during a first/second allocated resource if at least one of the said first conditions are satisfied.

In some embodiments, the first LP signal comprises at least one of: a signal with a OOK waveform or modulated by a OOK or FSK modulation method, the second type of the LP signal, the third type of the LP signal, the fourth type of the LP signal, and/or the fifth type of the LP signal.

In some embodiments, the second LP signal comprises at least one of: a signal with a CP-OFDM or DFT-s-OFDM waveform or modulated by using OFDM or encoded by a polar code, RM code, or convolutional code, the first type of the LP signal, the second type of the LP signal, the third type of the LP signal, the fourth type of the LP signal, the fifth type of the LP signal, and/or the sixth type of the LP signal.

In some embodiments, the first receiver comprises a OOK receiver or a simplified receiver.

In some embodiments, the second receiver comprises at least one of the simplified receiver or the legacy receiver.

In some embodiments, the first/second allocated resource includes at least one of the resource configured by the configuration information. In some embodiments, UE detects the first LP signal during the first allocated resource. In some embodiments, UE detects the second LP signal during the second allocated resource.

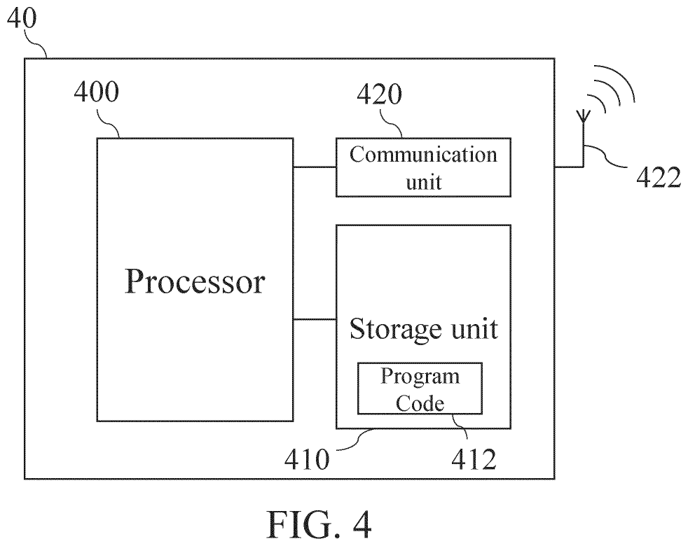

FIG. 4 relates to a schematic diagram of a wireless terminal 40 according to an embodiment of the present disclosure. The wireless terminal 40 may be a user equipment (UE), a mobile phone, a laptop, a tablet computer, an electronic book or a portable computer system and is not limited herein. The wireless terminal 40 may include a processor 400 such as a microprocessor or Application Specific Integrated Circuit (ASIC), a storage unit 410 and a communication unit 420. The storage unit 410 may be any data storage device that stores a program code 412, which is accessed and executed by the processor 400. Embodiments of the storage unit 412 include but are not limited to a subscriber identity module (SIM), read-only memory (ROM), flash memory, random-access memory (RAM), hard-disk, and optical data storage device. The communication unit 420 may a transceiver and is used to transmit and receive signals (e.g., messages or packets) according to processing results of the processor 400. In an embodiment, the communication unit 420 transmits and receives the signals via at least one antenna 422 shown in FIG. 4.

In an embodiment, the storage unit 410 and the program code 412 may be omitted and the processor 400 may include a storage unit with stored program code.

The processor 400 may implement any one of the steps in exemplified embodiments on the wireless terminal 40, e.g., by executing the program code 412.

The communication unit 420 may be a transceiver. The communication unit 420 may as an alternative or in addition be combining a transmitting unit and a receiving unit configured to transmit and to receive, respectively, signals to and from a wireless network node (e.g., a base station).

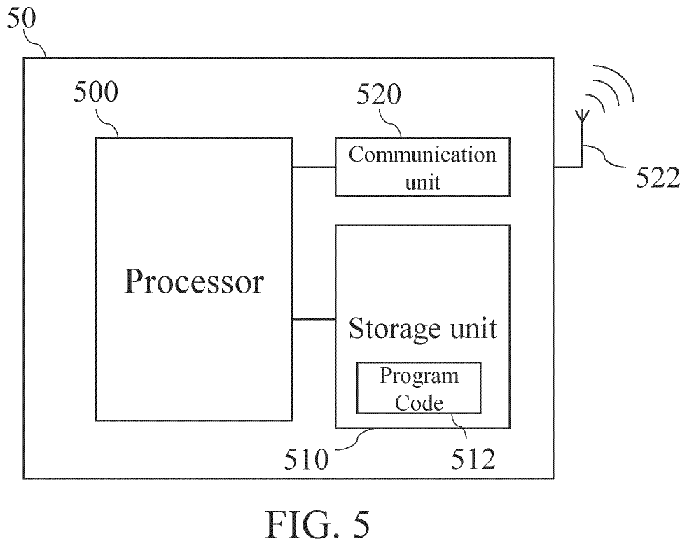

FIG. 5 relates to a schematic diagram of a wireless network node 50 according to an embodiment of the present disclosure. The wireless network node 50 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 50 may comprise (perform) at least one network function such as an access and mobility management function (AMF), a session management function (SMF), a user place function (UPF), a policy control function (PCF), an application function (AF), etc. The wireless network node 50 may include a processor 500 such as a microprocessor or ASIC, a storage unit 510 and a communication unit 520. The storage unit 510 may be any data storage device that stores a program code 512, which is accessed and executed by the processor 500. Examples of the storage unit 512 include but are not limited to a SIM, ROM, flash memory, RAM, hard-disk, and optical data storage device. The communication unit 520 may be a transceiver and is used to transmit and receive signals (e.g., messages or packets) according to processing results of the processor 500. In an example, the communication unit 520 transmits and receives the signals via at least one antenna 522 shown in FIG. 5.

In an embodiment, the storage unit 510 and the program code 512 may be omitted. The processor 500 may include a storage unit with stored program code.

The processor 500 may implement any steps described in exemplified embodiments on the wireless network node 50, e.g., via executing the program code 512.

The communication unit 520 may be a transceiver. The communication unit 520 may as an alternative or in addition be combining a transmitting unit and a receiving unit configured to transmit and to receive, respectively, signals to and from a wireless terminal (e.g., a user equipment or another wireless network node).

A wireless communication method is also provided according to an embodiment of the present disclosure. In an embodiment, the wireless communication method may be performed by using a first wireless communication node (e.g., a UE). In an embodiment, first wireless communication node may be implemented by using the wireless communication terminal 40 described in this disclosure, but is not limited thereto.

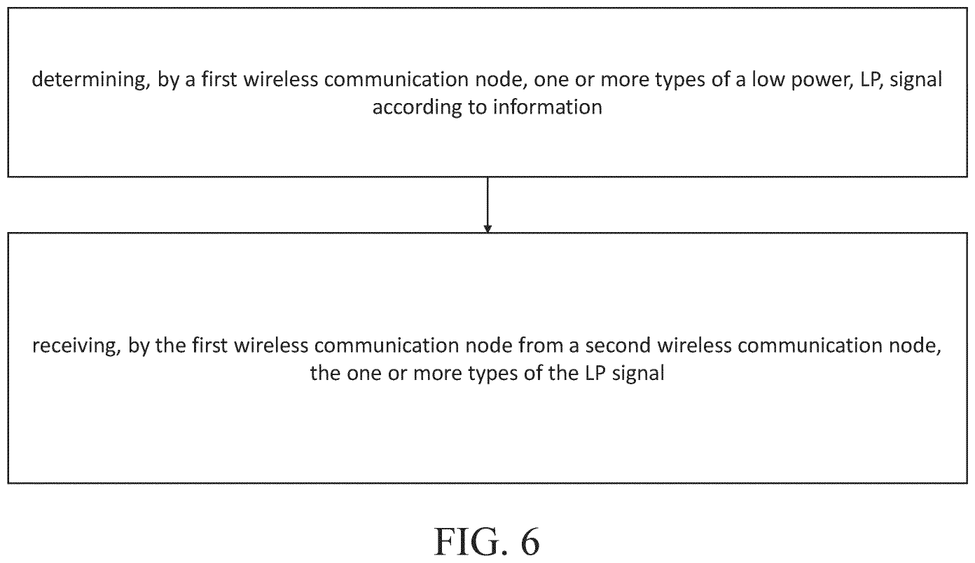

Referring to FIG. 6, in an embodiment, the wireless communication method includes: determining, by a first wireless communication node, one or more types of a low power, LP, signal according to information; and receiving, by the first wireless communication node from a second wireless communication node, the one or more types of the LP signal.

In an embodiment, the LP signal comprises at least one of a low power wake-up signal, LP-WUS, a low power synchronization signal, LP-SS, or a physical downlink control channel, PDCCH.

In an embodiment, the information comprises at least one of information configured by the second wireless communication node or information indicated by the LP signal.

Details in this regard can be ascertained with reference to the paragraphs above, and will not be repeated herein.

Another wireless communication method is also provided according to an embodiment of the present disclosure. In an embodiment, the wireless communication method may be performed by using a second wireless communication node (e.g., a gNB). In an embodiment, the second wireless communication node may be implemented by using the wireless communication node 50 described in this disclosure, but is not limited thereto.

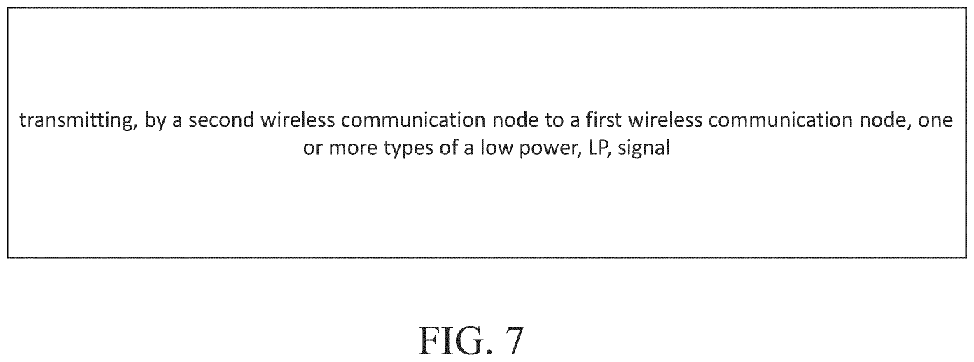

Referring to FIG. 7, in an embodiment, the wireless communication method includes transmitting, by a second wireless communication node to a first wireless communication node, one or more types of a low power, LP, signal.

In an embodiment, the first wireless communication node determines the one or more types of the LP signal according to information.

In an embodiment, the LP signal comprises at least one of a low power wake-up signal, LP-WUS, a low power synchronization signal, LP-SS, or a physical downlink control channel, PDCCH

In an embodiment, the information comprises at least one of information configured by the second wireless communication node or information indicated by the LP signal.

Details in this regard can be ascertained with reference to the paragraphs above, and will not be repeated herein.

In some embodiments, the first wireless communication node used in the present disclosure may indicate the UE described above. In some embodiments, the first wireless communication node used in the present disclosure may indicate a wireless communication device, a wireless communication terminal, a wireless communication receiver, a wireless communication user equipment, UE, a relay, an integrated access backhaul, IAB, node, or a repeater, but is not limited thereto.

In some embodiments, the second wireless communication node used in the present disclosure may indicate a next generation NodeB, gNB, a base station, a wireless communication device, a wireless communication transmitter, a relay, an IAB node, and/or a repeater, but is not limited thereto.

In some embodiments, the phrase receiving the LP signal used in the present disclosure may indicate receiving, monitoring, detecting and/or decoding the LP signal.

It will be understood that, in the present disclosure, the term “and/or” or symbol “/” may include any and all combinations of one or more of the associated listed items. For example, A and/or B and/or C includes any and all combinations of one or more of A, B, and C, including A, B, C, A and B, A and C, B and C, and a combination of A and B and C. Likewise, A/B/C includes any and all combinations of one or more of A, B, and C, including A, B, C, A and B, A and C, B and C, and a combination of A and B and C.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

What is claimed is:

1. A wireless communication method comprising:
determining, by a first wireless communication node, one or more types of a low power (LP) signal according to information; and
receiving, by the first wireless communication node from a second wireless communication node, the one or more types of the LP signal; and
wherein the LP signal comprises at least one of a low power wake-up signal (LP-WUS), a low power synchronization signal (LP-SS), or a physical downlink control channel (PDCCH); or
wherein the information comprises at least one of information configured by the second wireless communication node or information indicated by the LP signal.

2. The wireless communication method of claim 1, wherein the LP signal indicates indication information comprising at least one of:
a wake-up indication;
index information;
format information;
system information (SI) change information;
Subcarrier Spacing (SCS) information;
a transmission pattern;
an availability of the LP signal;
a capability of an LP signal receiver;
a type of the LP signal;
a capability of the LP signal;
Earthquake and Tsunami Warning System (ETWS) information; or
Commercial Mobile Alert System (CMAS) information.

3. The wireless communication method of claim 1, wherein the one or more types of an LP signal comprise at least one of:
a second type of the LP signal comprising at least one of a second signal format, a second generation procedure, a second function, a second monitoring method, a second waveform or a second size of information; or
a third type of the LP signal comprising at least one of a third signal format, a third set of indication information, a third generation procedure, a third modulation method, a third coding operation, a third function, a third monitoring method, a third waveform or a third size of information; wherein the third signal format comprises a first data packet.

4. The wireless communication method of claim 3, wherein the second type of the LP signal satisfies at least one of:
the second signal format being generated based on the second generation procedure including a second modulation method or a second coding operation; wherein the second modulation method includes at least one of: an on-off keying (OOK) modulation, or a Zadoff Chu (ZC) sequence;
the second function comprising synchronization;
the second waveform comprising at least one of CP-OFDM or DFT-s-OFDM or OOK waveform or FSK waveform;
the second size of information that is not less than 0 bit and is not larger than 10 bits; or
the second monitoring method comprising at least monitoring the third signal format according to the configuration of higher layer parameter.

5. The wireless communication method of claim 3, wherein the third type of the LP signal satisfies at least one of:
the third signal format carrying a third set of indication information including at least one of a wake-up indication, or index information;
the third signal format being generated based on the third generation procedure including a third modulation method and a third coding operation; wherein the third modulation method includes at least one of: an OOK modulation, a FSK modulation, a binary phase shift keying, BPSK, modulation, a quadrature phase shift keying (QPSK) modulation, a scrambling sequence, or a sequence-based modulation; and wherein the third coding operation includes a Manchester code, a Reed-Muller (RM) code, a convolutional code, a polar code, or a pulse interval encoding (PIE);
the third function comprising indicating indication information of LP signal;
the third waveform comprising at least one of CP-OFDM or DFT-s-OFDM or OOK waveform or FSK waveform;
the third size of information that is not less than 2 bits and not larger than 256 bits; or
the third monitoring method comprising at least monitoring the third signal format according to the configuration of higher layer parameter.

6. A wireless communication method comprising:
transmitting, by a second wireless communication node to a first wireless communication node, one or more types of a low power (LP) signal, wherein the first wireless communication node determines the one or more types of the LP signal according to information; and
wherein the LP signal comprises at least one of a low power wake-up signal (LP-WUS), a low power synchronization signal (LP-SS), or a physical downlink control channel (PDCCH); or
wherein the information comprises at least one of information configured by the second wireless communication node or information indicated by the LP signal.

7. The wireless communication method of claim 6, wherein the LP signal indicates indication information comprising at least one of:
a wake-up indication;
index information;
format information;
system information (SI) change information;
Subcarrier Spacing (SCS) information;
a transmission pattern;
an availability of the LP signal;
a capability of an LP signal receiver;
a type of the LP signal;
a capability of the LP signal;
Earthquake and Tsunami Warning System (ETWS) information; or
Commercial Mobile Alert System (CMAS) information.

8. The wireless communication method of claim 6, wherein the one or more types of an LP signal comprise at least one of:
a second type of the LP signal comprising at least one of a second signal format, a second generation procedure, a second function, a second monitoring method, a second waveform or a second size of information; or
a third type of the LP signal comprising at least one of a third signal format, a third set of indication information, a third generation procedure, a third modulation method, a third coding operation, a third function, a third monitoring method, a third waveform or a third size of information; wherein the third signal format comprises a first data packet.

9. The wireless communication method of claim 8, wherein the second type of the LP signal satisfies at least one of:
the second signal format being generated based on the second generation procedure including a second modulation method or a second coding operation; wherein the second modulation method includes at least one of: an on-off keying (OOK) modulation, or a Zadoff Chu (ZC) sequence, a long low PAPR sequence, or a low PAPR sequence; and wherein the second coding operation includes at least one of: a Reed-Muller (RM) code, a convolutional code or a Manchester code.
the second function comprising synchronization;
the second waveform comprising at least one of CP-OFDM or DFT-s-OFDM or OOK waveform or FSK waveform;
the second size of information that is not less than 0 bit and is not larger than 10 bits; or
the second monitoring method comprising at least monitoring the third signal format according to the configuration of higher layer parameter.

10. The wireless communication method of claim 8, wherein the third type of the LP signal satisfies at least one of:
the third signal format carrying a third set of indication information including at least one of a wake-up indication, or index information;
the third signal format being generated based on the third generation procedure including a third modulation method and a third coding operation; wherein the third modulation method includes at least one of: an OOK modulation, a FSK modulation, a binary phase shift keying (BPSK) modulation, a quadrature phase shift keying (QPSK) modulation, a scrambling sequence, or a sequence-based modulation; and wherein the third coding operation includes a Manchester code, a Reed-Muller (RM) code, a convolutional code, a polar code, or a pulse interval encoding (PIE);
the third function comprising at least one of synchronization or indicating indication information of LP signal;
the third waveform comprising at least one of CP-OFDM or DFT-s-OFDM or OOK waveform or FSK waveform;
the third size of information that is not less than 2 bits and not larger than 256 bits; or
the third monitoring method comprising at least monitoring the third signal format according to the configuration of higher layer parameter.

11. A wireless communication node, comprising:
a communication unit; and
at least one processor configured to: determine one or more types of a low power, LP, signal according to information; and receive, via the communication unit from a second wireless communication node, the one or more types of the LP signal;
wherein the LP signal comprises at least one of a low power wake-up signal (LP-WUS), a low power synchronization signal (LP-SS), or a physical downlink control channel (PDCCH); or
wherein the information comprises at least one of information configured by the second wireless communication node or information indicated by the LP signal.

12. A wireless communication node, comprising:
a communication unit; and
at least one processor configured to implement the method of claim 6.

13. A computer program product comprising a non-transitory computer-readable program medium having code stored thereupon, the code, when executed by at least one processor, causing the at least one processor to implement a wireless communication method recited in claim 1.

14. A computer program product comprising a non-transitory computer-readable program medium having code stored thereupon, the code, when executed by at least one processor, causing the at least one processor to implement a wireless communication method recited in claim 6.
